(19) United States
(12) Patent Application Publication
(10) Pub. No.: US 2005/0025912 A1
(43) Pub. Date: Feb. 3, 2005

(54) Image-recording medium

(76) Inventor: Yasuyuki Takeda, St. Paul (JP)

Correspondence Address: 3M INNOVATIVE PROPERTIES COMPANY, PO BOX 33427, ST. PAUL, MN, 55133-3427, US

(21) Appl. No.: 10/476,334

(22) PCT Filed: May 23, 2002
(86) PCT No.: PCT/US02/16437

(30) Foreign Application Priority Data
Aug. 6, 1999 (JP) 11/223918

(51) Int. Cl. B41M 5/00

(52) U.S. Cl. 428/32.18

(57) ABSTRACT

To provide an image-recording medium, which can form a high quality image thereon without yellowing (the shift of color tone) or the blotting of the ink with both the dye ink and the pigment ink. An image-recording medium having a support having breathing micropores, the surfaces and the micropores of which are made hydrophilic, and an ink-receptive layer which is provided on the surface of the support and comprises a binder and a coagulant, characterized in that the ink-receptive layer contains a cationic organic oligomer having a cationic functional group in the molecule, or a cationic polymer having a cationic functional group in the molecule as a coagulant.

### FIELD OF THE INVENTION

The present invention relates to an image-recording medium for recording an ink-image with a printing method such as an ink-jet printing method, and in particular, to an image-recording medium which can be adapted to both pigment inks and dye inks and record a high-quality image.

### BACKGROUND OF THE INVENTION

It is known that an image-recording medium comprising a support having breathing micropores, that is, a porous support, the surfaces and the micropores of which are made hydrophilic, is useful as an image-recording medium such as an ink-jet printing paper. Such an image-recording medium is disclosed in U.S. Pat. No. 5,605,750, WO99/03685, WO01/10650.

For example, WO99/03685 discloses an image-recording medium comprising a surfactant and a polyvalent metal salt which are contained in the micropores of a support comprising a porous film. The polyvalent metal salt is fixed in the micropores by imparting the hydrophilicity to the inner walls of the micropores with the surfactant and then applying a liquid containing the polyvalent metal salt. The ink is printed (or recorded) so that it is fixed to the surface of the support.

An ink-receptive layer may be provided on the support. Thus, the pigment contained in the ink is retained on the fixing surface, so that the migration of the pigment in the pores can be effectively prevented, and the coloring and the quick drying property can be improved. WO01/10650 (corresponding to JP-2001-47734 A) proposes the use of a layer comprising a water-soluble salt and an organic binder as an ink-receptive layer formed on the support which has breathing micropores.

The water-soluble salt functions as a coagulant, and quickly coagulates (or fixes) the pigment on the surface of the ink-receptive layer, when the ink is applied (by printing) to the surface of the medium (the surface of the ink-receptive layer). Thus, the migration of the pigment into the pores inside the medium is effectively prevented, and the quick drying property is enhanced.

The organic binder functions to fix (or bind) the coagulant in the ink-receptive layer in an effective manner. Thus, the water resistance of the fixed ink-image can be effectively improved by the synergistic effect of the coagulating function of the water-soluble salt and the binding function of the binder.

The content of the coagulant is usually from 1 to 70 parts by weight based on 100 parts by weight of the binder polymer.

JP-A-10-86505 discloses an ink-jet printing paper formed by applying a water-resistant agent for an ink-jet printing paper comprising a specific cationic urethane oligomer to a plain paper or a coated paper, although the printing paper disclosed is not an image-recording medium having a support the surface and micropores of which are made hydrophilic. When a paper sheet is used as an ink-jet printing medium, there arises a problem such that a dye may blot due to the adhesion of water after recording. Therefore, the use of a water-resistant agent is discussed.

As the water-resistant agent, cationic resins such as dicyandiamide condensates, polyamine and polyethyleneimine are known, but they suffer from some drawbacks such as insufficient water resistance, change of color tone, yellowing of white parts of a paper sheet, blotting of inks. The cationic urethane oligomer can improve the water resistance of printed images, and substantially prevent the change of color tone and the yellowing of white parts of a paper sheet, when a dye ink is used to print the paper sheet

The cationic urethane oligomer may be prepared by the polyaddition of the following compounds (A), (B) and (C) to obtain a polyurethane, and neutralizing at least a part of the tertiary amino groups of the polyurethane with an acid or quaternarizing at least a part of the tertiary amino groups with a quaternarizing agent:
(A) a polyol having at least two active hydrogen atoms reactive with an isocyanate group and a weight average molecular weight of 300 to 5,000;
(B) a diol, a triol, a diamine or a triamine having a tertiary amino group and a weight average molecular weight of less than 300;
(C) an organic isocyanate having at least two isocyanate groups. According to the detailed disclosure of this JP-A publication, the weight average molecular weight of the cationic urethane oligomer is less than 10,000 (about 1,000 to 8,000).

Recently, large-size ink jet printers, with which the kind of the ink can be switched between the pigment ink and the dye ink with a fingertip operation, are commercialized. Thus, it is natural for the users of such ink-jet printers to desire that image-recording media can be printed with the both types of inks without changing the kinds of the media. However, it has been very difficult to print the high quality image on the conventional image-recording media with both the dye ink and the pigment ink.

For example, in the case of the above-described ink-receptive layer containing the water-soluble salt and the organic binder, good quality images can be formed by printing with the pigment ink, but the color tone easily changes and thus the color of the color-printed image tends to shift to the yellow side.

The ink-jet printing paper comprising the cationic urethane oligomer has effects in the printing with the dye ink. However, in the case of printing with the pigment ink, the blotting of the printed areas tends to be remarkable. This is partly because the coloring component (pigment) in the ink tends to migrate to the pores inside the medium.

### SUMMARY OF THE INVENTION

The present invention provides an image-recording medium comprising (i) a support having breathing micropores, the surfaces and the micropores of which are made hydrophilic, and (ii) an ink-receptive layer which is provided on the surface of said support and comprises a binder and a coagulant, characterized in that said ink-receptive layer contains a cationic organic oligomer having a cationic functional group in the molecule, or a cationic polymer having a cationic functional group in the molecule as a coagulant.

The image-recording medium of the present invention comprises a porous support, the surfaces and micropores of which are made hydrophilic, and an ink-receptive layer which is provided on the surface of the support and comprises a binder and the cationic oligomer or polymer as the coagulant Thus, the high-quality images can be printed thereon without yellowing (the shift of color tone) or the remarkable blotting of the ink in the printing with both the dye ink and the pigment ink. Therefore, the present invention can provide an image-recording medium which can satisfy the desire of the users who wish the printing of media with both the dye ink and the pigment ink.

Accordingly, one object of the present invention is to provide an image-recording medium which can satisfy the desire of the users who wish the printing of media with the dye ink and the pigment ink without changing the kinds of the media.

More concretely, the object of the present invention is to provide an image-recording medium which can form a high quality image thereon without yellowing (the shift of color tone) or the remarkable blotting of the ink with both the dye ink and the pigment ink.

When the water-soluble salt is used as the coagulant, the color tone changes in the case of the printing with the dye ink. As disclosed in JP-A-10-86505, the cationic organic oligomer is an excellent water-resistant agent which improves the quality of the image formed with the dye ink. However, the cationic organic oligomer alone has an inferior coagulation function to the water-soluble salt-based coagulant. That is, the cationic organic oligomer should be further improved to quickly coagulate the pigment on the surface of the ink-receptive layer and prevent the migration of the pigment into the pores inside the support, when the pigment ink is applied on the surface of the medium.

### DESCRIPTION OF THE PREFERRED EMBODIMENT

According to the present invention, the support having the surface and the micropores which are made hydrophilic is used to make up the weak point of the cationic organic oligomer, which appears in the printing with the pigment ink, and thus the conformity of the medium to the pigment ink is improved.

The detail of such a synergistic function has not been clarified, but it may be considered as follows:

In general, to increase the coagulation function, a low molecular weight compound having a high ion dissociation property is advantageous like the water-soluble salt. The molecular weight of the compound has an influence on the number of ions which can dissociate per a unit volume of the ion-receptive layer. Thus, in general, the cationic organic oligomer having the low ion dissociation property cannot increase the coagulation function. On the other hand, the yellowing in the printing with the dye ink more easily occurs as the number of the dissociable ions increases. This may be because the dye reacts with the ions to form a complex of a complex-like substance and thus the absorption wavelength of light shifts. Accordingly, from the viewpoint of the prevention of yellowing, the cationic organic oligomer is more advantageous than the water-soluble salt. The weak point of the cationic organic oligomer with respect to the coagulating function can be compensated with the hydrophilic porous support. The coagulation reaction of the cationic organic oligomer with the pigment is retarded when a dispersion medium of the ink remains at the printed area for an excessively long time, since the organic oligomer has a less interaction with the pigment than the water-soluble salt. It is supposed that the hydrophilic porous support quickly absorbs the dispersion medium of the printing ink and functions to increase the quick drying property and accelerate the coagulation reaction with the pigment.

The ink-receptive layer may consists of a single layer containing the mixture of the binder polymer and the cationic polymer (or oligomer). Preferably, the ink-receptive layer has a laminate structure of two layers as described below:

That is, the ink-receptive layer comprises (ii-1) an base layer having a back surface which faces the surface of the support and a surface opposite to the back surface, and containing the binder, and (ii-2) an upper layer containing the coagulant at least a part of which is impregnated in the base layer so that it is localized near the surface of the base layer.

When such an ink-receptive layer is used, the function to prevent yellowing and also ink blotting can be more effectively improved both in the printing with the dye ink and in the printing with the pigment ink. When the ink-receptive layer has the two-layer structure, the binder in the ink-receptive layer preferably comprises an ion-modified polymer.

Coagulant

The coagulant is a cationic organic oligomer having a cationic functional group in the molecule (a cationic oligomer), or a cationic organic polymer having a cationic functional group in the molecule (a cationic polymer).

The cationic oligomer has an intermediate molecular weight between that of the low molecular weight coagulant such as the water-soluble salt and that of the polymer.

The weight average molecular weight of the cationic oligomer is usually from 500 to 10,000.

The weight average molecular weight of the cationic polymer is usually from 10,000 to 1,000,000.

The cationic oligomer or polymer has at least one cationic functional group selected from the group consisting of nitrogen-containing cationic functional groups, sulfonium salts (e.g.—S⁺R₂·X⁻ in which R is a methyl group or a hydrogen atom, and X is a halide ion) and phosphonium salts (e.g.—P⁺R₃·X⁻ in which R is a methyl group or a hydrogen atom, and X is a halide ion).

The nitrogen-containing cationic functional group is at least one group selected from the group consisting of amine salts, quaternary ammonium salts (e.g.—N⁺R₃·X⁻ in which R is a methyl group or a hydrogen atom, and X is a halide ion), pyridium salts (e.g. —N⁺C₅H₅·X³¹ in which X is a halide ion) and polyethylenepolyamine (e.g.—NH(C₂ N₄H)ₘH in which m is a number of 2 to 4).

When the cationic oligomer or polymer is contained in the ink-receptive layer in admixture with the binder polymer, it preferably contains, in the molecule, at least one cationic salt functional group selected from the group consisting of sulfonium salts, phosphonium salts, quaternary ammonium salts and pyridinium salts. Such cationic salt funcitonal groups are advantageous for the prevention of yellowing since they have a moderate ion dissociation property, and also exhibit the coagulation function so that the blotting in the case of printing with the pigment ink by means of the hydrophilic porous support. When the binder of the ink-receptive layer comprises an ion-modified polymer, in particular, a polymer having an anionic functional group, the cationic polymer does not interacts with the ion-modified polymer in a paint for the formation of the ink-receptive layer, and thus the cationic polymer can maintain the stably dispersed or dissolved state without the coagulation. From such a viewpoint, the polymer or oligomer having the quaternary ammonium salt in the molecule is particularly preferable.

As the cationic polymer, polymers having backbones comprising polyamine, polyurethane, polyurea, polyester or polyoxyalkylene ether, each containing the cationic functional group in the molecule may be used. Likewise, oligomers having backbones comprising polyamine, polyurethane, polyurea, polyester or polyoxyalkylene ether each containing the cationic functional group in the molecule may be used as the cationic oligomer.

The cationic polyurethane to be used in the present invention may be prepared by a conventional process for the synthesis of polyurethane. For example, it is prepared by the reaction of a polyisocyanate and a polyol mixture containing a polyol having a cationic functional group such as a quaternary ammonium group.

When the cationic functional group is the quaternary ammonium group, the cationic polyurethane may be prepared by quaternarizing a precursor which has been prepared by the reaction of (1) a mixture of a compound having an active hydrogen and a tertiary amine group in the molecule and a polyol, and (2) a polyisocyanate. Such reactions can be performed as follows:

Firstly, a polyol having at last two active hydrogen atoms reactive with the isocyanate group as a raw material oligomer forming the backbone, and a solvent having no active hydrogen are charged in a reaction vessel which has been replaced with nitrogen. The weight average molecular weight of the polyol is usually from 300 to 5,000.

Then, a polyisocyanate having at least two isocyanate groups is added to the vessel and heated at a temperature of 60° C. or higher for several hours to allow the polyisocyanate to react with the raw material oligomer. After cooling the reaction product obtained in this reaction to a temperature of 50° C. or less, an amino group-containing compound having an active hydrogen and a tertiary amine group is added to the reaction produt. Furthermore, the mixture is heated and reacted at a temperature of 60° C. or higher for several hours. Thus, a polyurethane prepolymer as a cationic oligomer precursor is obtained. As the amino group-containing compound, a diol, a triol, a diamine or a triamine each having an active hydrogen and a tertiary amine group in the molecule may be used. The weight average molecular weight of such a compound is usually less than 300.

The urethane prepolymer obtained is reacted with an acid to quaternarize the tertiary amino group.

Finally, excessive water is added to the reaction mixture to kill the unreacted isocyanate groups followed by the post-reaction around 50° C. for several hours to obtain an aqueous solution containing the intended cationic oligomer (the cationic polyurethane oligomer).

Examples of the above polyol include polypropylene glycol, polytetramethylene glycol, polyethylene glycol, polyaddition products of bisphenol A and propylene oxide, polyaddition products of bisphenol S and propylene oxide, adipic acid-based polyester, isophthalic acid-based polyester.

Examples of the above amino group-containing compound include N-methyl-N,N-diethanolamine, N-ethyl-N,N-diethanolamine, N-isobutyl-N,N-diethanolamine, triethanolamine, methyliminobispropylamine, butyliminobispropylamine, tri(2-aminoethyl)amine.

As the polyisocyanate, those conventionally used for the synthesis of polyurethane may be used. Examples of the conventional polyisocyanate include aliphatic diisocyanates such as tetramethylene diisocyanate, 1,6-hexamethylene diisocyanate, dodecamethylene diisocyanate, trimethylhexamethylene diisocyanate.

Specific examples of the cationic polymer to be used in the present invention are a cationic polyamine containing a quaternary ammonium salt group available from NIKKA Chemical Co., Ltd. under a trade name of NEOFIX® IJ1450, and a cationic polyamide resin available from NIPPON PMC Co., Ltd. under a trade name of WS SERIES®.

Specific examples of the cationic oligomer to be used in the present invention are a cationic polyurethane containing a quaternary ammonium salt group available from NIKKA Chemical Co., Ltd. under a trade name of NEOFIX® IJ-150, an organic oligomer containing a quaternary ammonium salt group available from Witco Chemical under a trade name of Emcol® CC-9, Emcol® CC-36 or Emcol® CC42.

The amount of the cationic oligomer or polymer to be contained as the coagulant in the ink-receptive layer is usually from 1 to 40 parts by weight, preferably from 3 to 35 parts by weight, particularly preferably from 5 to 30 parts by weight, based on 100 parts by weight of the binder polymer. When the content of the cationic oligomer or polymer is too low, the coagulating activity decreases so that the blur of the ink-image may appear in the printing with the pigment ink. When this content is too high, the yellowing may appear in the printing with the dye ink.

The cationic oligomer or polymer and the anionic organic oligomer may be used at the same time insofar as the effects of the present invention are not impaired. The anionic organic oligomer has a backbone comprising polyurethane, polyurea, polyester or polyoxyalkylene ether, and an anionic functional group. Examples of the anionic functional group are carboxylate salt groups, sulfonate salt groups, phosphate ester salt groups.

Furthermore, amphoteric oligomers such as betaine or sulfobetaine oligomers may be used also.

The weight average molecular weight of the oligomer which can be used together with the cationic oligomer or polymer is usually from 500 to 8,000.

Support

The support may comprise a film or sheet having breathing micropores (which will be referred to as “porous film” collectively), and its surface and micropores are made hydrophilic. The kind of the porous film is not limited insofar as the above-described effects are achieved, and any support, that is conventionally used in the image-recording medium, may be used. For example, stretched resin films such as TESLIN® porous film (an stretched porous resin film of PPG Industries) is preferably used.

The permeability of the porous film is usually from 10 to 3,000 sec/100 ml, preferably from 50 to 2,500 sec/100 ml, particularly preferably from 100 to 2,000 sec/100 ml, in terms of a Gurley permeability.

Herein, the Gurley permeability is a value measured with a Gurley permeability tester according to JIS P-8117-1980, and expressed by a time (seconds) necessary to allow 100 ml of the air to pass through a sample.

Examples of the material of the porous film include polyethylene, polypropylene, polymethylpentene-1, polyvinyl chloride, polyvinylidene chloride, polystyrene, styrene-butadiene-acrylonitrile copolymers, polyamide, polycarbonate, acrylic resins, polyesters, copolymer polyesters, and the like. They may be used as a mixture of two or more. Among them, general resins such as polyolefin (e.g. polypropylene, high density polyethylene) are preferable, from the viewpoint of water resistance and costs.

The porous film may optionally contain inorganic fine powder to increase the porosity of the film. Examples of the inorganic fine powder include calcium carbonate, alumina, calcined clay, silica, and the like. The particle size of the fine powder is usually from 0.3 to 10 μm, preferably from 0.8 to 5 μm. In addition, the porous film may contain other additives such as a heat stabilizer, a UV absorber, a dispersant, an antistatic agent, an antioxidant, an oil (e.g. mineral oil), and so on.

The porous film can be produced by stretching a resin composition comprising the above-described resin and optionally the inorganic fine powder and other additives. Examples of the stretching machine include an inflation film forming machine, an inflation film forming machine equipped with an inner mandrel, a T-die film forming machine equipped with a tenter or machine-direction stretching rolls and a tenter. The stretching may be performed uniaxially or biaxially.

The porosity of the porous film (that is, the total volume of the pores in the whole volume of the film) is usually from 10 to 90 vol. %, preferably from 20 to 80 vol. %. When the porosity is too low, the quick-drying property may deteriorate. When the porosity is too high, the firmness (mechanical strength) of the support decreases so that the recording media may not be smoothly supplied and discharged.

The diameter of the pores measured on the cross section vertical to the wall thickness direction of the film (that is, in the horizontal direction of the stretched film) is usually from 0.01 to 3 μm, preferably from 0.02 to 2 μm, more preferably from 0.03 to 1 μm.

The whole thickness of the support is from 30 to 1,000 μm, preferably from 50 to 500 μm. When the thickness of the support is too thin, the ink-drying property may deteriorate. When the thickness is too large, the handling of the recording medium may become troublesome. The image-recording medium of the present invention can be printed with various types of ink-jet printers and the like, although the medium having a too large thickness may not be printed with some printers.

In one preferred embodiment of the present invention, the surfaces and micropores of the support are treated with a surfactant to impart hydrophilicity to them. Such a hydrophilic treatment can be carried out at the same time as the formation of the ink-receptive layer by adding the surfactant to the paint for the formation of the ink-receptive layer and applying the paint to the surface of the support However, it is preferable to carry out such a hydrophilic treatment prior to the formation of the ink-receptive layer.

Firstly, a liquid containing the surfactant is applied to the surface of the support or the support is dipped in the liquid containing the surfactant to make the surfaces and micropores of the support hydrophilic. Then, the liquid containing the binder resin and the cationic oligomer is applied to the surface of the hydrophilicly treated support to form the ink-receptive layer. This method can easily produce the image-recording medium having the quick-drying property.

The surfactant may be any of anionic, cationic, amphoteric and nonionic surfactants. The anionic surfactants include carboxylate salt type, sulfonate salt type and phosphate salt type ones. The cationic surfactants include amine salt type and quaternary ammonium type ones, the amphoteric surfactants include betaine type and sulfobetaine type ones, and the nonionic surfactants include polyoxyalkylene type ones (e.g. polyethylene glycol), sorbitane type and sorbitol type ones.

When the hydrophilic treatment is carried out by the application and drying of the liquid containing the surfactant, a medium is preferably water or alcohol such as ethanol. The concentration of the surfactant in the liquid is usually from 1 to 30% by weight, preferably from 5 to 25% by weight.

As an application means, a conventional coater such as a bar coater, a knife coater, a roll coater, a die coater may be used.

The hydrophilic treatment with the surfactant may be omitted, when the whole porous film or a part near the surface of the film contains a relatively large amount of amorphous silica particles to impart the hydrophilicity to the support The particle size of the silica particles is usually from 0.3 to 10 μm, preferably from 0.8 to 5 μm. The content of the silica particles is usually from 30 to 60% by weight, preferably from 35 to 55% by weight, based on the whole weight of the film.

Ink-Receptive Layer

Examples of the binder polymer of the ink-receptive layer include polyurethane, polyolefin, polyvinyl chloride, polyvinylidene chloride, polystyrene, styrene-butadiene-acrylonitrile copolymers, polyamide, acrylic polymers, polyesters, and the like. Preferably, an ion-modified polymer is used. The ion-modified polymer retains the pigment or the dye at the printed area of the support in cooperation with the cationic oligomer or polymer and functions to enhance the effect to prevent the blotting. From such a viewpoint, the combination of the ion-modified polymer and the cationic polymer is preferable. Usually, a water-dispersible ion-modified polymer is used.

The ion-modified polymer, which is preferably used in the present invention, is a cation-modified polymer such as a cation-modified polyurethane, a cation-modified polyester. The ink-receptive layer containing the cation-modified polymer is particularly advantageous to improve the water resistance of the image printed with the ink-jet printing.

One specific example of the ion-modified polymer is an ion-modified polyurethane disclosed in JP-A-10-181189, which comprises a mixture of polyurethane having a sulfonic acid group in the molecule and epichlorohydrin-polyamide. Epichlorohydrin-polyamide may be prepared by polycondensation of adipic acid and diethylenetriamine with dehydration. The polyurethane having a sulfonic acid group in the molecule may be prepared by polymerizing the first diol having a sulfonic acid group in the molecule, the second diol having no sulfonic acid group in the molecule, and a diisocyanate. The first diol may be prepared with the transesterification of dimethyl sodiumsulfoisophthalate with a diol.

Specific examples of the commercially available ion-modified polymers are PATERACOL® IJ-170 (a paint containing a cation-modified polyurethane and inorganic fine powder) and PATERACOL® IJ-21 (a paint containing a cation-modified polyurethane and no inorganic fine powder) both available from DAINIPPON INK AND CHEMICALS, INC., and so on.

The ink-receptive layer preferably contains an inorganic fine powder to increase the porosity of the ink-receptive layer and further improve the ink-drying property. As the inorganic fine powder, calcium carbonate, alumina, calcined clay, silica (including amorphous silica), diatomaceous earth, talc, titanium oxide, barium sulfate, and the like may be used. The particle size of the fine powder is usually from 0.3 to 10 μm, preferably from 0.8 to 5 μm.

The amount of the inorganic fine powder is usually from 15 to 65 parts by weight, preferably from 25 to 55 parts by weight, based on the 100 parts by weight of the binder. When the amount of the inorganic fine powder is too small, the ink-drying property may not be improved. When the amount of the inorganic fine powder is too large, the ink-receptive layer tends to have insufficient mechanical strength.

Furthermore, the ink-receptive layer may contain other additives such as a heat stabilizer, a UV absorber, a dispersant, an antistatic agent, an antioxidant.

The ink-receptive layer may be formed, for example, by applying the liquid containing the cationic oligomer and the binder polymer to the hydrophilic surface of the support and then drying the applied liquid. In this case, the solvent is preferably water or an alcohol.

Alternatively, a layer containing the binder is firstly formed, and then the liquid containing the coagulant such as the cationic polymer is applied and dried to form the ink-receptive layer. In particular, when the coagulant is a material having a high film-forming property such as the cationic polymer, it is easy to form the ink-receptive layer in which at least a part of the upper layer is impregnated in the base layer. That is, firstly the base layer containing the binder polymer for the base layer is formed, and then a paint containing the coagulant is applied on the base layer and dried to form the upper layer containing the coagulant so that the upper layer is localized near the surface of the base layer. When the layer containing the binder (the base layer) is firstly formed and then the paint containing the coagulant is applied to the surface of such a layer, the coagulant is localized in the surface part of the ink-receptive layer to which the ink is applied, and thus the effect of the coagulant is advantageously enhanced. In such a case, it is preferable for the base layer to contain the inorganic fine powder so that at least a part of the upper layer is easily impregnated in the base layer.

As an application means used in the process to form the ink-receptive layer, a conventional coater such as a bar coater, a knife coater, a roll coater, a die coater may be used.

The concentration of the cationic olymer (or oligomer) contained in the paint for the upper layer is usually from 0.5 to 30% by weight, preferably from 1 to 25% by weight

The thickness of the whole ink-receptive layer may vary in a wide range. On one hand, the ink-receptive layer preferably has a relatively large thickness to prevent the blur of the ink-image. On the other hand, the ink-receptive layer is preferably thin to suppress the decrease of the color development due to the sinking of the coloring material of the ink. From these viewpoints, the thickness of the ink-receptive layer is usually from 5 to 100 μm, preferably from 10 to 50 μm.

When the ink-receptive layer comprises the base layer and the upper layer, the thickness of the base layer is usually from 4.7 to 99 μm, preferably from 9.5 to 49 μm, and that of the upper layer is selected so that the thickness of the base layer is in this range, and the thickness of the whole ink-receptive layer is in the above-defined range. For example, the thickness of the upper layer including the part impregnated in the base layer is usually from 0.3 to 40 μm. In general, the thickness of the upper layer is smaller than that of the base layer.

Application of Recording Medium

The image-recording medium of the present invention may be used to record the ink-image with a printer such as an ink-jet printer.

In general, the ink comprises a colorant comprising a pigment or a dye, and a solvent such as water, alcohol. The recording medium of the present invention has particularly good performances and effectively improves the quick-drying property and water resistance in the recording with the ink-jet printer using the aqueous inks (comprising water as the solvent). The printing conditions may be the same as those employed to print a conventional recording paper. Accordingly, the recording medium of the present invention is advantageous in that it requires no special printing conditions.

The recording medium of the present invention may be used as a structural material of an adhesive sheet for decoration. For example, an adhesive layer containing an adhesive such as a pressure-sensitive adhesive is provided on the surface of the support opposite to the ink-fixing surface, and a liner which protects the adhesive surface of the adhesive layer is provided to form a laminate consisting of the recording medium, the adhesive layer and the liner. This laminate is printed with the printer like the recording medium as such to print the decoration pattern on the ink-fixing surface of the recording medium (the surface of the ink-receptive layer) to obtain the adhesive sheet for decoration. The adhesive sheet according to the present invention may be adhered to the surface of an adherent such as a wall, a signboard, a sign, a vehicle body, a pane and decorate the adherent.

### EXAMPLES

### Example 1

A support used in this Example was a porous film containing amorphous silica, which had a thickness of 350 μm, a porosity of 65% by volume and a pore size of 0.01 to 1 μm. This porous film was Teslin® SP1400 of PPG Industries.

On one surface of the support, a paint having the following composition was applied with a bar coater and dried to form an ink-receptive layer to obtain the recording medium of this Example, which can be used as a structural material of an adhesive sheet for decoration. The applied layer was dried at 100° C. for 3 minutes, and the thickness of the ink-receptive layer was 17 μm.

<Composition of Paint for Ink-Receptive Layer>
Binder: PATERACOL® IJ-170 100 wL parts
Coagulant: NEOFIX® IJ-150 13 wt. parts

PATERACOL® IJ-1170 is a coating composition containing a water-dispersible cation-modified polyurethane and about 50% by weight of silica particles, which is available from DAINIPPON INK AND CHEMICALS, INC. NEOFIX® IJ-150 is a coating composition containing a cationic organic oligomer having a quaternary ammonium salt group in the molecule available from NIKKA Chemical Co., Ltd.

The amount of the coagulant component (the cationic organic oligomer) in the paint for the receptive layer was 20 parts by weight based on 100 parts by weight of the binder polymer.

### Example 2

This Example relates to an ink-receptive layer having the localized structure of an upper layer and a base layer.

Firstly, a paint for the base layer was prepared in the same manner as in Example 1 and the base layer was formed on the support Then, a paint for the upper layer containing the coagulant was applied to the surface of the base layer and dried to form the ink-receptive layer.

The coagulant used in this Example was a cationic polymer having a quaternary ammonium salt group available under a trade name of NEOFIX® IJ-450 (a paint containing 60 wt. % of a cationic polymer, which was used after diluting it to reduce the concentration of the cationic polymer to 3 wt. %). The paint for the upper layer was applied with a bar coater and dried at 100° C. for 3 minutes. The thickness of the whole ink-receptive layer was 18 μm.

### Example 3

A recording medium of this Example was prepared in the same manner as in Example 2 except that a coagulant in the upper layer was changed to the following one:

WS 535 (a cationic polyamide resin available from NIPPON PMC Co., Ltd.)

WS 535 is a coating composition containing 35 wt. % of a cationic polymer, and the concentration of the cationic polymer in the paint for the upper layer was 5 wt. %.

### Comparative Example 1

A recording medium of this Example was prepared in the same manner as in Example 1 except that no coagulant was added to the paint for the receptive layer.

### Comparative Example 2

A recording medium of this Example was prepared in the same manner as in Example 1 except that aluminum sulfate-14-18H₂O was used as a coagulant in a paint for the receptive layer. The content of aluminum sulfate was 15 parts by weight based on 100 parts by weight of the binder polymer.

### Comparative Example 3

A recording medium of this Example was prepared in the same manner as in Example 1 except that a non-porous film was used as a support The non-porous film used was a white PET film having a thickness of 75 μm (Crysper® K1211 available from TOYOBO).

The surface of the ink-receptive layer (fixing surface) of the image-recording medium prepared in each Example was printed under the following conditions, and the printing properties were evaluated by the following methods.

The results of the evaluation are shown in Tables 1 and 2.

Printing Conditions and Evaluation Conditions

(A) Printing with Dye Inks
Printer used: Canon BJ F8500
Inks used: BCI-8C (cyan), BCI-8M (magenta), BCI-8Y (yellow), BCI-8PC (photo cyan), BCI-8PM (photo magenta), BCI-8PBK (photo black)

Printing Conditions:
Printing mode: Best Quality Mode; Paper. High quality paper

Evaluation of Print Quality

The ISO standard image N2 (cafeteria image) was printed under the above conditions and coloring and blotting were observed.

Color Density

A monochrome pattern of cyan, magenta yellow or black was printed and the color density of the printed pattern was measured with a color densitometer Spectrodensitometer® (available from X-Rite).

Color Change

A monochrome pattern of cyan, magenta yellow or black was printed and a color difference (ΔE) of each color of the printed pattern of Examples 1-2 and Comparative Example 2 was measured using the color of the printed pattern of Comparative Example 1 (no coagulant) as the standard.

Drying Time

A time at which a printed area in which the four colors, cyan, magenta, yellow and black were mixed (400%) lost the surface gloss was measured.

Water Resistance

A monochrome pattern of cyan, magenta, yellow or black was printed, and dipped in water at 20° C. for one hour. Then, the color density of the pattern image was measured and the decrease of the color density in comparison with that prior to dipping was evaluated. Furthermore, the blotting of the ink or the condition of the printed pattern was observed after dipping.

(B) Printing with Pigment Inks
Printer used: Noajet III (available from Encad)
Inks used: Pigment Inks 8500 Series (available from 3M)

Printing Conditions:
Ink jet rate: 5,000 Hz; Print direction: single direction; No. of passes: 4 passes

Evaluation of Print Quality

A built-in test pattern was printed under the above conditions, and bleeding (boundary blur) and feathering (single blur) were observed.

Water Resistance

A pattern of cyan, magenta, yellow or black was printed, and dipped in water at 40° C. for one hour. Then, the color density of the pattern image was measured and the decrease of the color density in comparison with that prior to dipping was evaluated. Furthermore, the blotting of the ink or the condition of the printed pattern was observed after dipping.

The color density and the drying time were measured in the same manners as in the case of the printing with the dye inks.

TABLE 1
Evaluations for Dye Inks

| | Ex. 1 | Ex. 2 | Ex. 3 | C. E. 1 | C. E. 2 | C. E. 3 |
|---|---|---|---|---|---|---|
| Print | Very | Very | Very | Very | Color | Black |
| quality | good | good | good | good | fairly | ink |
| | | | | | shifted to | severely |
| | | | | | yellow | blotted |
| | | | | | side | |
| Drying time | 5 | 5 | 5 | 5 | 5 | 120 |
| (sec.) | | | | | | |
| Color | C: 1.50 | C: 1.46 | C: 1.65 | C: 1.57 | C: 1.47 | C: 1.43 |
| density | M: 1.38 | M: 1.38 | M: 1.42 | M: 1.36 | M: 1.26 | M: 1.39 |
| | Y: 0.87 | Y: 0.94 | Y: 0.98 | Y: 0.88 | Y: 0.82 | Y: 0.88 |
| | B: 1.65 | B: 1.55 | B: 1.64 | B: 1.56 | B: 1.63 | B: 1.54 |
| Color | C: 0.87 | C: 2.38 | C: 1.43 | C: 0.00 | C: 11.03 | C: |
| change | M: 0.55 | M: 2.60 | M: 3.70 | M: 0.00 | M: 3.90 | M: |
| (ΔE relative | Y: 0.61 | Y: 2.61 | Y: 3.04 | Y: 0.00 | Y: 3.44 | Y: |
| to C. E. 1) | B: 0.53 | B: 1.88 | B: 0.43 | B: 0.00 | B: 0.67 | B: |
| Water | C: 1.57 | C: 1.45 | C: 1.65 | C: 1.60 | C: 1.57 | C: 1.39 |
| resistance | M: 1.39 | M: 1.38 | M: 1.38 | M: 1.35 | M: 1.36 | M: 1.20 |
| (color | Y: 0.88 | Y: 0.92 | Y: 0.94 | Y: 0.87 | Y: 0.82 | Y: 0.77 |
| density after | B: 1.61 | B: 1.59 | B: 1.61 | B: 1.52 | B: 1.62 | B: 1.39 |
| dipping) | No blot- | No blot- | No blot- | No blot- | No blot- | Much |
| | ting | ting | ting | ting | ting | blotting |

TABLE 2
Evaluations for Dye Inks

| | Ex. 1 | Ex. 2 | Ex. 3 | C. E. 1 | C. E. 2 | C. E. 3 |
|---|---|---|---|---|---|---|
| Print | Very | Very | Very | Much | Very | Cracked |
| quality | good | good | good | single | good | at CMYB |
| | | | | blur and | | (400%) |
| | | | | bound- | | printed |
| | | | | ary blur | | area |
| Drying time | 100 | 100 | 100 | 100 | 100 | about |
| (sec.) | | | | | | 60 min. |
| Color | C: 1.36 | C: 1.39 | C: 1.35 | C: 1.37 | C: 1.48 | C: 1.26 |
| density | M: 1.06 | M: 1.07 | M: 1.05 | M: 1.08 | M: 1.06 | M: 1.01 |
| | Y: 0.91 | Y: 0.94 | Y: 0.94 | Y: 0.93 | Y: 0.92 | Y: 0.88 |
| | B: 1.42 | B: 1.39 | B: 1.34 | B: 1.39 | B: 1.47 | B: 0.85 |
| Water | C: 1.36 | C: 1.38 | C: 1.35 | C: 1.36 | C: 1.48 | C: 1.24 |
| resistance | M: 1.04 | M: 1.05 | M: 1.03 | M: 1.06 | M: 1.05 | M: 0.99 |
| (color | Y: 0.89 | Y: 0.92 | Y: 0.93 | Y: 0.92 | Y: 0.90 | Y: 0.85 |
| densiy after | B: 1.40 | B: 1.40 | B: 1.32 | B: 1.39 | B: 1.47 | B: 1.36 |
| dipping) | No blot- | No blot- | No blot- | No blot- | No blot- | No blot- |
| | ting | ting | ting | ting | ting | ting |

1. An image-recording medium comprising
(i) a support having breathing micropores, the surfaces and the micropores of which are made hydrophilic, and (ii) an ink-receptive layer which is provided on the surface of said support and comprises a binder and a coagulant,
characterized in that said ink-receptive layer contains a cationic organic oligomer having a cationic functional group in the molecule, or a cationic polymer having a cationic functional group in the molecule as a coagulant.

2. The image-recording medium according to claim 1, wherein the cationic functional group of said cationic oligomer or polymer is at least one cationic functional salt group selected from the group consisting of a sulfonium salt, a phosphonium salt, a quaternary ammonium salt and a pyridinium salt.

3. The image-recording medium according to claim 1, wherein said support contains amorphous silica particles, whereby the hydrophilicity is imparted to the surface and the micropores of said support.

4. An image-recording medium comprising
(i) a support having breathing micropores, the surfaces and the micropores of which are made hydrophilic, and (ii) an ink-receptive layer which is provided on the surface of said support and comprises a binder and a coagulant,
characterized in that said ink-receptive layer comprises
(ii-1) an base layer having a back surface which faces the surface of said support and a surface opposite to the back surface, and containing said binder, and (ii-2) an upper layer containing said coagulant at least a part of which is impregnated in said base layer so that it is localized near the surface of said base layer
and that said upper layer contains a cationic organic oligomer having a cationic functional group in the molecule, or a cationic polymer having a cationic functional group in the molecule as a coagulant.

5. The image-recording medium according to claim 4, wherein the binder of said ink-receptive layer comprises an ion-modified polymer.
